(19) United States
(12) Patent Application Publication
(10) Pub. No.: US 2025/0018617 A1
(43) Pub. Date: Jan. 16, 2025

(54) Manufacturing Method to Increase Electroactive Phase (?-phase) and Enhance Ferroelectric Properties of Polyvinylidene Fluoride (PVDF) Membranes

(71) Applicant: Soroosh Mahmoodi, Tehran (IR)

(72) Inventor: Soroosh Mahmoodi, Tehran (IR)

(21) Appl. No.: 18/222,430

(22) Filed: Jul. 15, 2023

(51) Int. Cl. B29C 41/04; B29C 41/50

(52) U.S. Cl. CPC B29C 41/04; B29C 41/50; B29K 2027/16; B29K 2995/0003; B29K 2995/0008

(57) ABSTRACT

A manufacturing method is disclosed to increase the β phase, increase the electroactivity, and enhance the ferroelectric and magnetic properties of Polyvinylidene Fluoride (PVDF) membranes. The method also improves the electromagnetic interference of PVDF films. The method includes spreading a PVDF solution with any concentration and within any solvents on the surface of a substrate of any shape and size by spinning the substrate horizontally. Then, the coated PVDF layer goes through a centrifugation process after spreading and before the complete evaporation of solvents. The centrifugation process can be generated by any centrifugation device where the centrifugation force is directed perpendicular to the substrate surface. In other words, technically, after spinning the substrate around a vertical spinning axis and depositing material, a centrifugation force is immediately exerted perpendicular to the surface of the coated PVDF layer on the substrate surface within a rotation around a horizontal axis.

### BACKGROUND OF THE INVENTION

### 1. Field of the Invention

The present application relates to the field of Polyvinylidene Fluoride (PVDF) membranes and, more particularly, to manufacturing PVDF membranes with a higher percentage of β phase, higher electroactivity, and higher magnetic and ferroelectric performance.

### 2. Description of the Related Art

This section offers background information related to the present disclosure, which is not necessarily prior art. The present invention concerns a method for manufacturing Polyvinylidene Fluoride (PVDF) membranes that display higher piezoelectric and better magnetic and ferroelectric properties.

Mechanical stress induces the accumulation of an electric charge in PVDF material, which is known as piezoelectricity. PVDF is a polymer that shows promise as a piezoelectric and ferroelectric material. PVDF can crystallize into multiple phases with different chain conformations known as α, β, and γ phases. Only the β-phase has strong ferroelectric and piezoelectric properties because of its planar conformation and high dipole density. Ferroelectric materials contain a permanent dipole that lets them keep a polar electric field when not subjected to an external field. PVDF has been widely used as piezoelectric material to build sensors, microelectromechanical systems (MEMS), piezoelectric vibration energy harvesters, actuators, self-powering devices, electronic skins, transducers, nonvolatile memories, etc., for different applications such as pressure sensors, intelligent wearable electronics, biomedical engineering aspects, aerospace applications, and recently data storages. The ferroelectric effect always relates the various force to electric properties, which can be applied in transducers. The flexibility and low cost of polymers facilitate the application of ferroelectric polymers in transducers. When the device functions as a sensor, a mechanical or acoustic force applied to one of the surfaces causes material compression. Via the direct piezoelectric effect, a voltage is generated between the electrodes. In actuators, a voltage applied between the electrodes causes a strain on the film through the inverse piezoelectric effect. Soft transducers in the form of ferroelectric polymer foams have been proven to have great potential.

The PVDF material mainly refers to the homopolymer of vinylidene difluoride, the copolymer of vinylidene difluoride, and some other vinylidene monomers containing Fluoride. The primary factor influencing the piezoelectricity of PVDF is its crystalline phase, which has five crystalline varieties: α, β, γ, δ, and ε. Among them, the β phase has a planar zigzag all-trans conformation (TTT) with the —CF2- group and the —CH2- group on either side of the molecular chain, and the dipole moments are placed parallel and perpendicular to the c-axis. Therefore, this conformation is the most polar conformation with the largest electric dipole moment and the maximum electroactivity. For a better understanding, a drawn schematic in the following shows the most common phases of a PVDF material.

The piezoelectric performance strongly depends on the function of the piezoelectric thin films, especially on their transverse piezoelectric properties, indicating that the deposition of high-quality piezoelectric thin films is a crucial technology. Different methods have been utilized to induce dipole alignment to enhance the β-phase proportion in PVDF. The methods of producing PVDF piezoelectric materials include stretching, blending, thermal annealing, high-voltage electric field polarization, tape casting, solution casting, Langmuir Blodgett deposition process, thermal drawing, spin coating, electrospinning, etc.

The stretching and thermal annealing processes are complicated and only slightly improve the piezoelectric output of pure PVDF compared to other approaches. Polarization under a high electric field, such as electrospinning, is an effective method to enhance the piezoelectric output of PVDF. A strong electric field force during the electrospinning process can facilitate the directional alignment of the —CH2-/-CF2- dipoles and transform the α phase into the β phase leading to the increase of the β-phase content in the PVDF nanofibers. However, the limitation of the polarization direction leads to a lack of flexibility in device design, and the preparation procedures are also complicated and time-consuming. The tape casting, coating, and thermal drawing also need post-treatment (such as high-voltage electric field polarization and thermal annealing) to make PVDF materials have better piezoelectric properties. The ferroelectric β phase can be obtained using a drawing process.

Solvent polarity can affect the formation of the β phase. A solvent with a high dipole moment facilitates the dipole alignment of polymer chains. Because solvent processing cannot be used easily in industry, thermo-mechanical processing is another main method to induce the β phase of PVDF. The role of thermo-mechanical fields determined by melt processing methods, thus, should not be overlooked, including pressure-quenching, pressing-and-folding, non-isothermal crystallization, extrusion-rolling, uniaxially stretching, and so on. The cooling rate is also a critical factor, and the β phase can be induced by quenching. Compression using high pressure can also create high amounts of β phase. However, the abovementioned methods are complicated and time-consuming for related industries.

Post-stretching offers a further opportunity to induce the orientation of polymer chains in thin films, which facilitates the achievement of required structures, properties, and functions. Uniaxial stretching along the machine direction (MD) is a basic post-stretching mode in the polymer film industry. The structures and properties differ along MD and transverse direction (TD). Compared to uniaxial stretching, biaxially stretched polymer films can be useful because of well-controlled film thickness and isotropic properties. Biaxially oriented PVDF films were achieved with stretching. Both crystallinity and β phase content, as well as tensile strength, were increased by increasing the stretching ratio. However, the method demands a time-consuming process and is not promising to increase the β phase.

Spin coating is a famous low-cost method employed to manufacture thin films of PVDF membranes. The steady shear stress was introduced to PVDF during spin-coating that can work as a mechanical stretching. The speed of spin coating and the following baking temperature are two important factors in controlling shearing force and crystallization time. The spin coating can produce a thin film with thickness from the nanoscale to the microscale. The film thickness can be well controlled by spin speed and solution concentration. The thickness of spin coating film can be reduced effectively by increasing spin coating speed or decreasing solution concentration. However, facile spin coating alone is not a promising method to enhance the dipole orientation of a PVDF membrane to increase the electroactivity or enhance the ferroelectric β-phase. In this presented patent, a modified manufacturing method of spin coating is disclosed. Besides low-cost and short operation time without any further heat treatment, the invention ensures enhancing the dipoles orientation of a PVDF membrane, increases the electroactivity, and enhances the ferroelectric properties.

### SUMMARY OF THE INVENTION

In this patent, a method of PVDF membrane manufacturing is disclosed. PVDF solution with any concentration and within any solvents is dispended on the surface of a substrate of any shape and size by spinning the substrate horizontally. Then, after spreading and before the complete evaporation of solvents, the coated PVDF layer goes through a centrifugation process. The centrifugation process can be generated by any centrifugation device where the centrifugation force is directed perpendicular to the substrate surface. In other words, technically, after depositing PVDF material and spinning the substrate around a vertical spinning axis, a centrifugation force is immediately exerted perpendicular to the surface of the coated PVDF layer on the substrate surface within a rotation around a horizontal axis. Therefore, a force perpendicular to the substrate surface is generated, where the force values depend on the distance of the substrate surface from the center of the rotation axis and the rotation velocity. The exerted acceleration increases the weight of all elements of the polymer. Therefore, the heavier elements of PVDF, such as Fluoride, will be much heavier than the lighter elements, such as Hydrogens. The increase in the difference between the weight of heavier and lighter atoms causes the heavier atoms of polymer to move downward of the coated film and the lighter atoms to rotate upward toward the coated layer's free surface. Therefore, centrifugation enhances the crystalline structure of the PVDF membrane in such a way that most of the heavier atoms are accumulated on one side, and most of the lighter atoms are accumulated on the other side (opposite side). By the mentioned definition of crystalline structure, the beta phase of PVDF membranes manufactured by the disclosed method increases. Furthermore, increasing the percentage of the beta phase will correspondingly increase the electroactivity of manufactured PVDF membranes. The centrifugation process also obliges the solvents, which are generally lighter than the polymers, to move toward the free surface of the wet layer and be evaporated quickly. Furthermore, the rotation of the substrate and coated layer in one system around the horizontal axis in an air atmosphere during the centrifugation process generates an airflow on the top surface of the coated layer. The airflow passes the coated layer's free surface, increasing the evaporation rate. The centrifugation will continue until the coating solvents are partially or completely evaporated. The fast evaporation of solvents significantly reduces the manufacturing time, which is of most interest to industries.

### Experiments

Seven samples of PVDF membranes under various centrifugation acceleration are prepared to verify the abovementioned effects of centrifugation force. A known amount of Polyvinylidene Fluoride (PVDF) powder (Mw˜534,000 g/mol, purchased from Aldrich) is stirred into a binary solvent system within a fixed volume ratio of N, N-Dimethylformamide (DMF), and Acetone as 5:5 (both purchased from Sinochem), respectively. The PVDF solution is prepared at a 16 wt % concentration of PVDF powder. To obtain a 5 mL solution, 0.8228 grams of PVDF powder was stirred into a mixed solvent of 2.5 mL DMF and 2.5 mL Acetone. The PVDF solution was stirred at 40° C. for 12 hours and rested enough to reach room temperature (25° C.).

A 2-inch glass wafer is cleaned with 95% ethanol, washed with deionized water, and dried with airflow. 0.5 ml of the prepared PVDF solution is deposited at the center of the wafer. Sample1 membrane is manufactured by the disclosed method under natural earth's gravity (1 g) (looks like the conventional spin coating method). Samples 2-7 are manufactured by the disclosed method and processes under centrifugation values ranging from 10 to 500 g. The following table represents the manufacturing parameters for all 7 membranes.

| Samples | Spinning Speed | Spinning Time | Centrifugation force | Centrifugation time |
|---|---|---|---|---|
| 1 | 1400 RPM | 30 Seconds | Non (1 g | Non |
| | | | earth's gravity) | |
| 2 | 1400 RPM | 30 Seconds | 50 g | 500 Seconds |
| 3 | 1400 RPM | 30 Seconds | 100 g | 500 Seconds |
| 4 | 1400 RPM | 30 Seconds | 150 g | 500 Seconds |
| 5 | 1400 RPM | 30 Seconds | 200 g | 500 Seconds |
| 6 | 1400 RPM | 30 Seconds | 300 g | 500 Seconds |
| 7 | 1400 RPM | 30 Seconds | 500 g | 500 Seconds |

The results of experiments on the manufactured PVDF membranes by the disclosed method employing X-Ray Diffractometer (XRD), Fourier Transform Infrared Spectroscopy (FTIR), Raman Spectroscopy, and Scanning Electron Microscopy (SEM) all approve a notable change in crystalline structure and a significant increment in beta phase. Furthermore, the manufactured membranes are testified for their electroactivity performance, showing increased electroactivity responses for the PVDF films fabricated by the disclosed method. Moreover, moment vs. magnetic field (M-H) graphs are obtained by a Vibrating Sample Magnetometer (VSM) device for the samples manufactured by the disclosed method under different centrifugation forces. The M-H graphs obtained by VSM approved a significant improvement in the ferroelectric and magnetic properties of PVDF membranes manufactured under higher centrifugation forces by the disclosed method. The abovementioned results are completely explained and discussed in the experiments section. The manufacturing time evaluations experimentally show that a PVDF membrane with high electroactivity performance using the disclosed method can be fabricated around 180 seconds with a centrifugation force of 500 g. This manufacturing time is one of the most desired targets in related industries.

### BRIEF DESCRIPTION OF THE DRAWINGS AND FIGURES

FIG. 1 is a side view of a coating deposition process on the top surface of a substrate located on a spinning chuck of a conventional spin coater.

FIG. 2 is a side view of the spinning process of the deposited coating on the surface of the substrate during a conventional spin coating process.

FIG. 3 is a side view of a centrifugation process perpendicular to the surface of the coated film while rotating the substrate around a horizontal axis perpendicular to the spinning axis.

FIG. 4 is a schematic showing the amorphous crystalline structure of PVDF polymer and its atoms inside a coated PVDF wet layer.

FIG. 5 is a schematic showing the effect of centrifugation force on the polymeric crystalline structure of coated PVDF wet layer and showing the solvent evaporation under the generated airflow during the centrifugation process.

FIG. 6 is a side view of a process to cut the edges of the dried PVDF membrane and uncouple the membrane from the edges of the substrate.

FIG. 7 is a side view of peeling off the dried PVDF membrane.

FIG. 8 is a side view of the process of washing the substrate after the peeling-off process.

FIG. 9 is a side view of a process to dry the surface of the substrate by airflow while spinning the substrate.

FIG. 10 shows the disclosed method's processes and explains each process.

FIG. 11 shows X-Ray Diffraction (XRD) graph for 7 samples of PVDF membranes synthesized by the disclosed method under various centrifugation forces.

FIG. 12 shows a Fourier Transform Infrared Spectroscopy (FTIR) graph for 7 samples of PVDF membranes synthesized by the disclosed method under various centrifugation forces.

FIG. 13 shows a Raman Spectroscopy graph for 7 samples of PVDF membranes synthesized by the disclosed method under various centrifugation forces.

FIG. 14 shows moment vs. magnetic field (M-H) graphs obtained with a Vibrating Sample Magnetometer (VSM) device for 7 samples of PVDF membranes synthesized by the disclosed method under various centrifugation forces.

FIG. 15 is a surface SEM image of sample1 (500×) membrane synthesized under natural earth's gravity (without exerting any centrifugation force).

FIG. 16 is a magnified surface SEM image of sample1 (3000×) membrane synthesized under natural earth's gravity (without exerting any centrifugation force).

FIG. 17 is a cross-section SEM image of sample1 (1000×) membrane synthesized under natural earth's gravity (without exerting any centrifugation force).

FIG. 18 is a magnified cross-section SEM image of sample1 (3000×) membrane synthesized under natural earth's gravity (without exerting any centrifugation force).

FIG. 19 is a surface SEM image of sample3 (500×) membrane synthesized under 100 g exerting centrifugation force.

FIG. 20 is a magnified surface SEM image of sample3 (3000×) membrane synthesized under 100 g exerting centrifugation force.

FIG. 21 is a cross-section SEM image of sample3 (1000×) membrane synthesized under 100 g exerting centrifugation force.

FIG. 22 is a magnified cross-section SEM image of sample3 (3000×) membrane synthesized under 100 g exerting centrifugation force.

FIG. 23 is surface SEM image of sample5 (500×) membrane synthesized under 200 g exerting centrifugation force.

FIG. 24 is a magnified surface SEM image of sample5 (3000×) membrane synthesized under 200 g exerting centrifugation force.

FIG. 25 is a cross-section SEM image of sample5 (1000×) membrane synthesized under 200 g exerting centrifugation force.

FIG. 26 is a magnified cross-section SEM image of sample5 (3000×) membrane synthesized under 200 g exerting centrifugation force.

FIG. 27 is a surface SEM image of sample7 (500×) membrane synthesized under 500 g exerting centrifugation force.

FIG. 28 is a magnified surface SEM image of sample7 (3000×) membrane synthesized under 500 g exerting centrifugation force.

FIG. 29 is a cross-section SEM image of sample7 (1000×) membrane synthesized under 500 g exerting centrifugation force.

FIG. 30 is a magnified cross-section SEM image of sample7 (3000×) membrane synthesized under 500 g exerting centrifugation force.

### DESCRIPTION OF THE EMBODIMENTS, DRAWINGS, FIGURES, AND EXPERIMENTS RESULTS

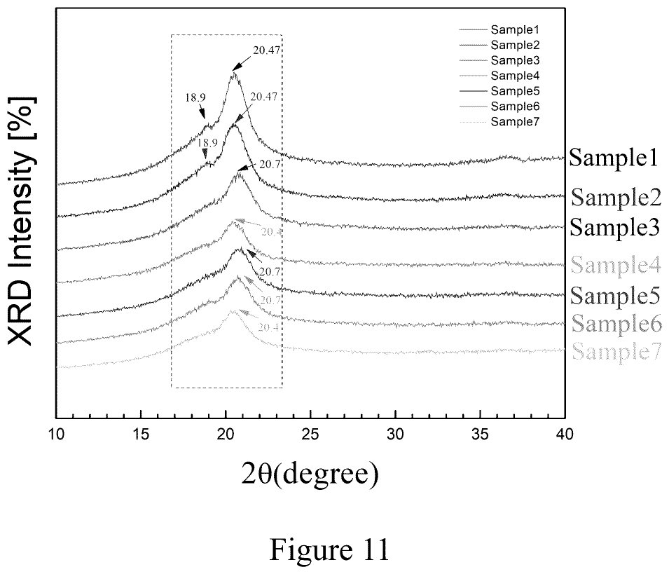

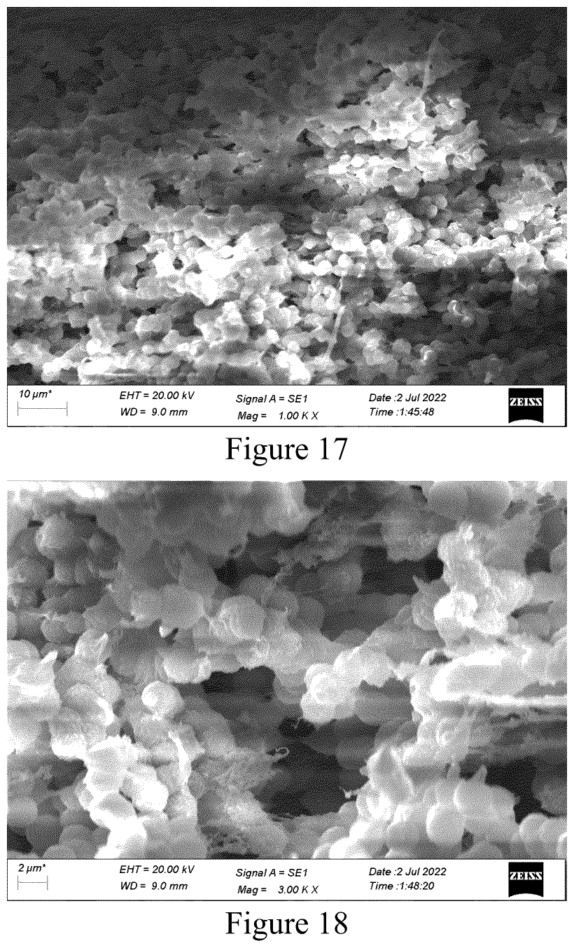

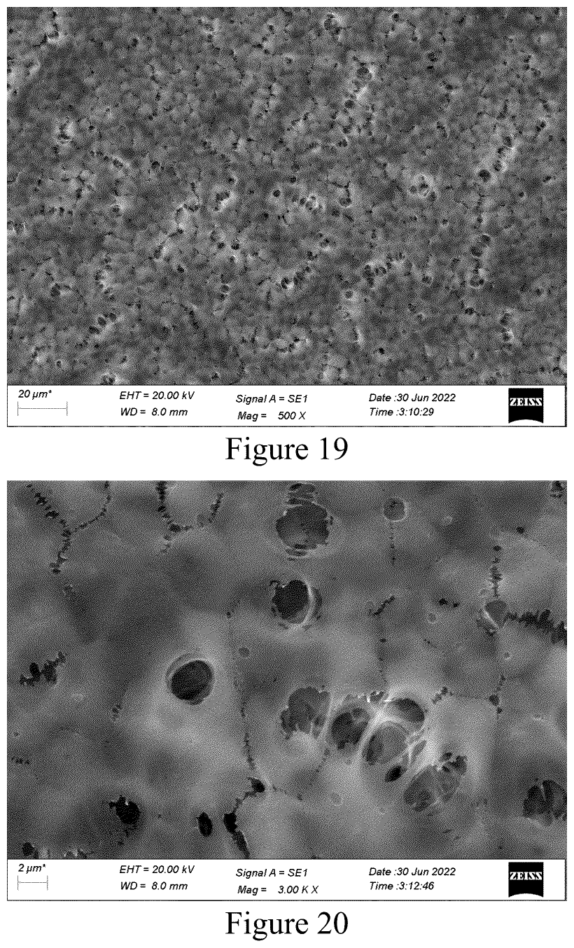

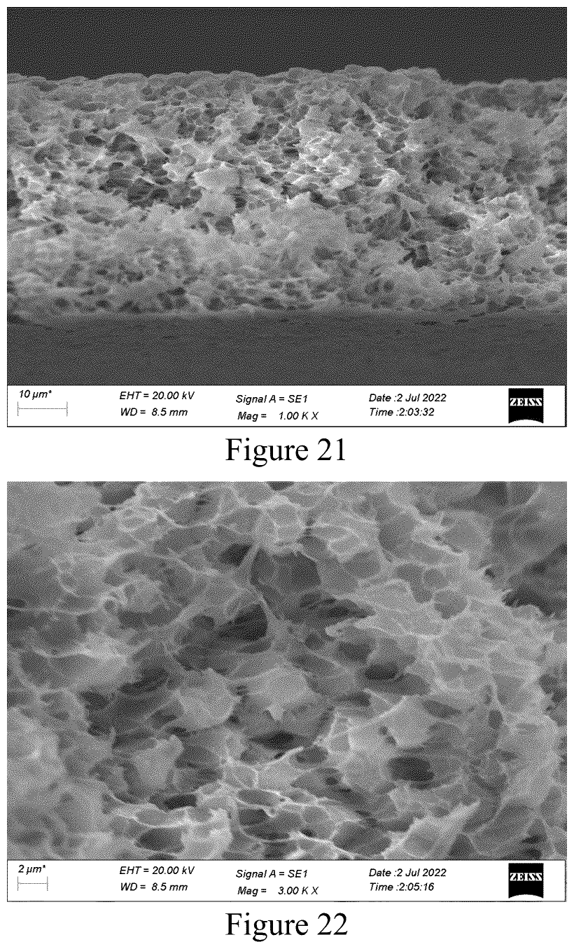

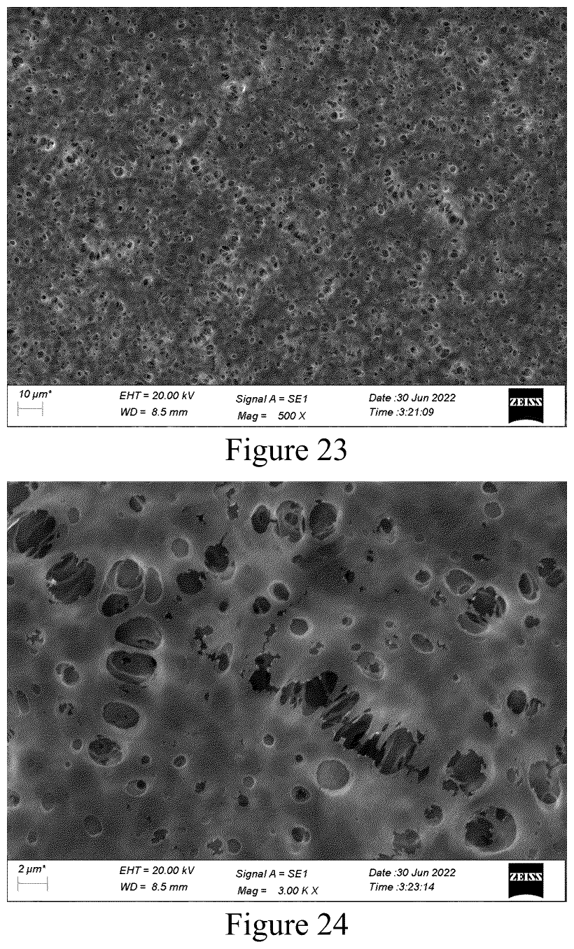

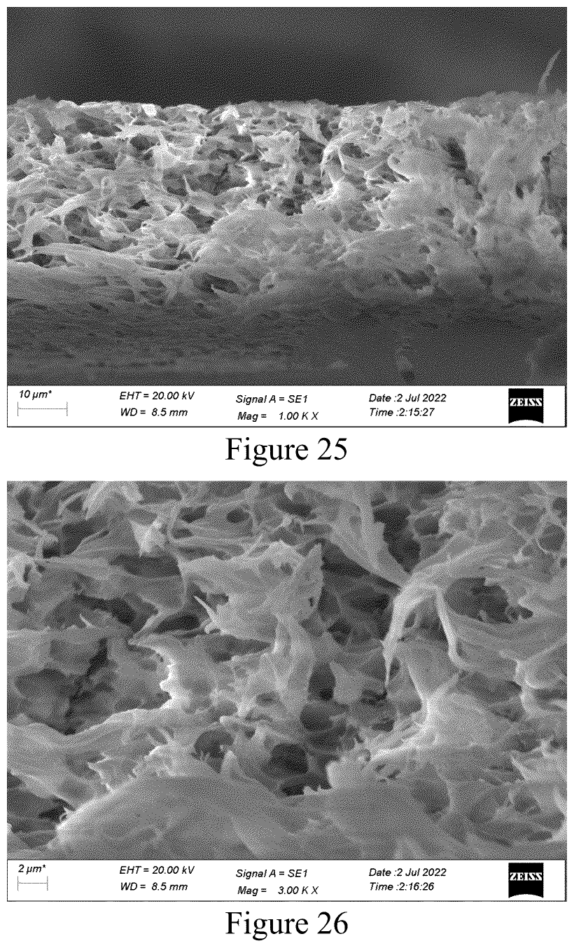

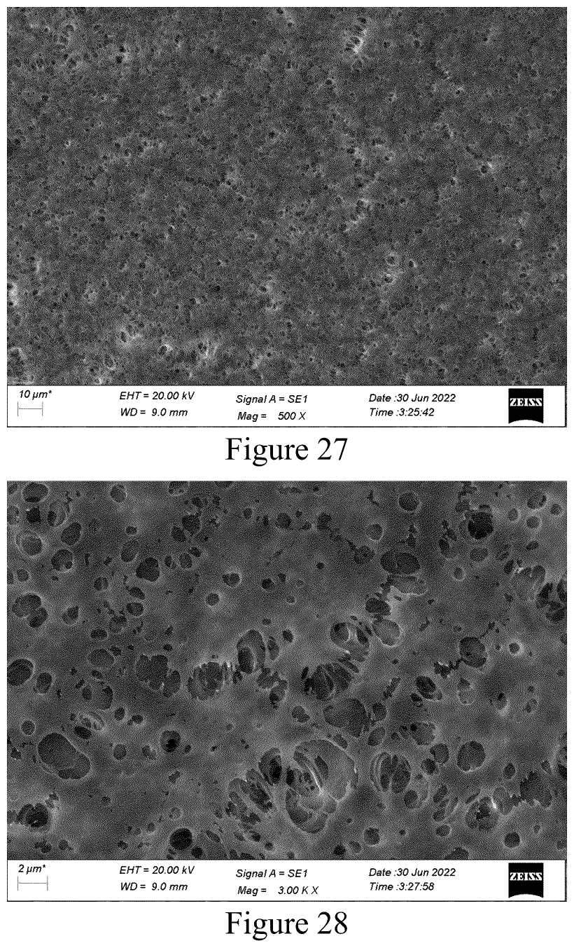

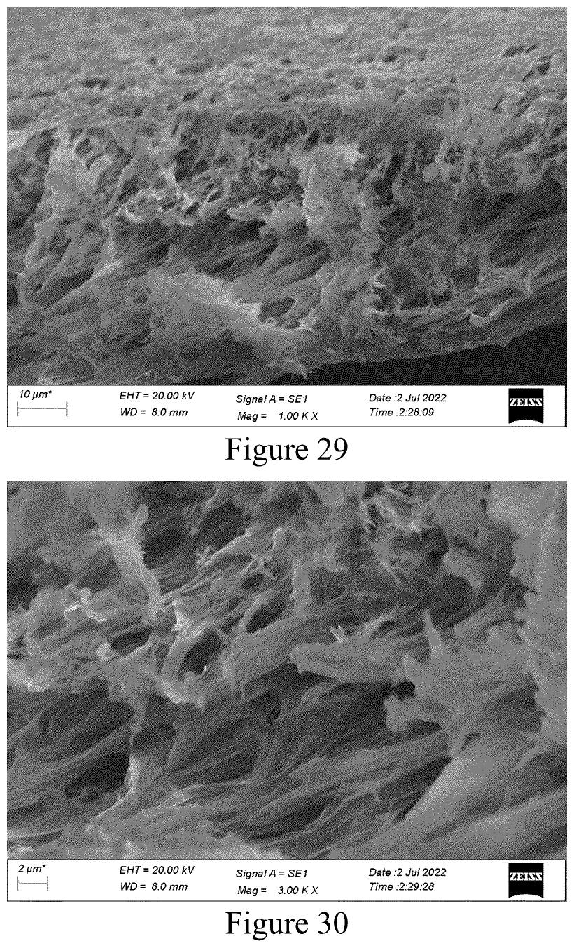

This section explains the disclosed method and the invention drawings and embodiments from FIGS. 1 to 10 in detail. Furthermore, the experimental results in FIGS. 11 to 30 are explained and discussed.

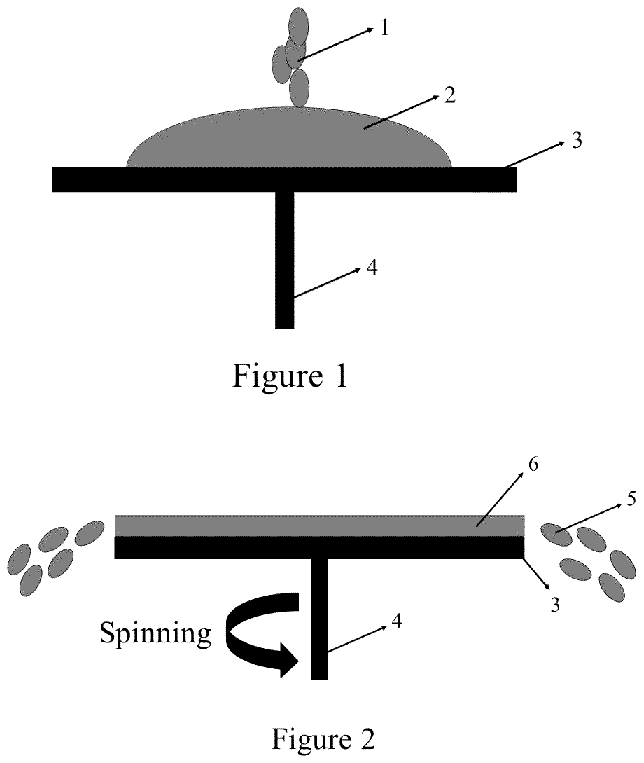

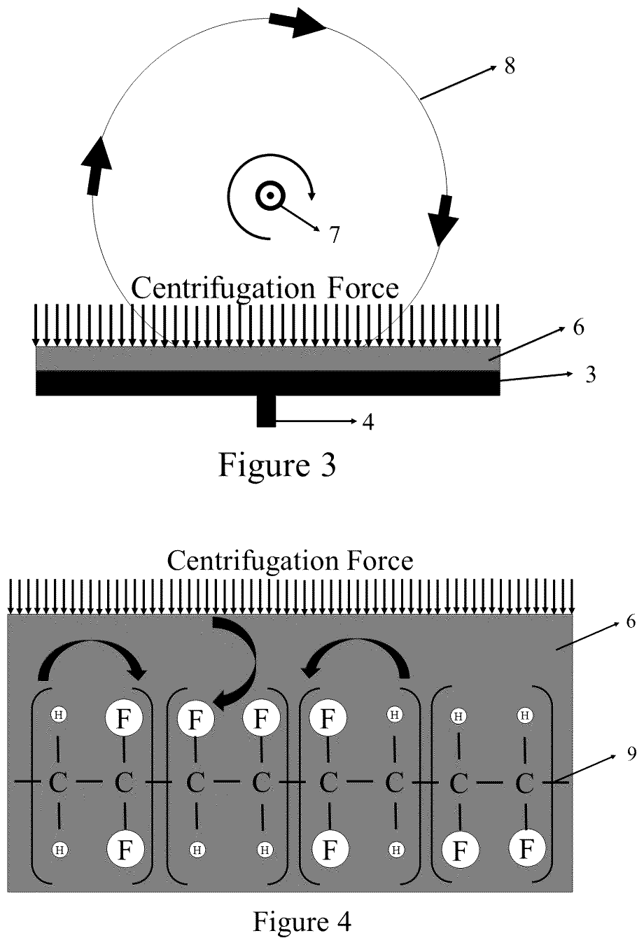

FIG. 1 shows a deposition process of coating 1 that is particularly a PVDF solution with any concentration and solvents, which can be accompanied by mixing any other material as the copolymers. The coating is deposited on the surface of a substrate 3 of any shape and size. The deposited coating 1 is accumulated like a curved shape 2 on the surface of substrate 3. Substrate 3 is located on a spinning chuck of a rotating system that looks like a conventional spin coater in which the spinning axis 4 is vertical. FIG. 2 shows a spinning process in which substrate 3 and deposited coating 2 spin around the axis 4 to spread the deposited coating 2 and manufacture a wet layer 6. During the spinning process, some amount of coating material 5 spread out from the edges of substrate 3. The thickness of the wet film 6 strongly depends on the spinning speed and viscosity of the coating material 1. The abovementioned processes are common and well-known as the conventional spin coating method. However, in this disclosed method, a centrifugation force perpendicular to the substrate 6 is generated within a centrifugation mechanism by a rotation 8 of the substrate 3 and wet film 6 around a horizontal axis 7, which is perpendicular to the spinning axis 4. The centrifugation process, immediately after spreading the coating material on the surface of the substrate 3 and before significant evaporation of solvents from the wet layer 6, is initiated, which all are represented in FIG. 3.

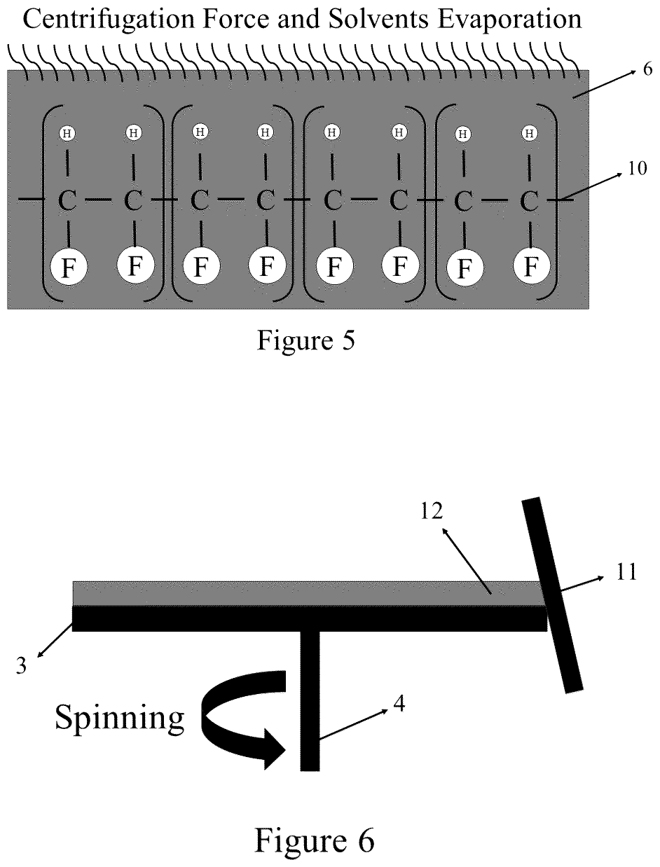

FIG. 4 represents a schematic for the crystalline structure 9 of the PVDF wet layer 6. The crystalline structure 9 consists of two back-bone Carbon atoms (C) in the center, two Fluoride atoms (F), and two Hydrogen atoms (H), sometimes at the head and sometimes at the tail, which constructs an amorphous crystalline structure 9 that is known as alpha (a) phase of PVDF material. The amorphous crystalline structure 9 shows that the Fluoride atoms (F) are randomly located on the top and somewhere else at the bottom. Furthermore, as can be seen in FIG. 4, the disclosed method proposes the centrifugation force obliges the denser (heavier) atoms, such as Fluoride (F) rotate in the polymeric chain structure of PVDF and go downward of the wet layer 6, and vice versa, the lighter atoms such as Hydrogen (H) rotate and move upward of the wet layer 6 while the centrifugation force is exerting. The black arrows in FIG. 4 show a schematic of how the atoms, due to their density difference, are rotating within the chain polymeric structure of the wet PVDF layer 6 under the elevated centrifugation force. FIG. 5 shows a schematic of a crystalline structure 10 of PVDF material inside the wet PVDF layer 6. The crystalline structure 10 shows that the denser (heavier) atoms of polymer, such as Fluoride (F), rotate downward of the wet layer 6, and the lighter atoms of polymer, such as Hydrogen (H), move upward inside the wet PVDF layer 6 toward the surface. The crystalline structure 10 with the abovementioned arrangements of atoms where the Fluoride (F) atoms are positioned on one side, and the Hydrogen (H) atoms on the other side of the polymer, which is known as the Beta (B) phase of PVDF material. Furthermore, FIG. 5 shows that the lighter solvent elements compared with the heavier polymer particles, quickly move toward the free surface of the wet layer 6 and can be evaporated faster under an airflow generated during rotation 8 while exerting the centrifugation force.

FIG. 6 represents that the centrifugation force is initiated until all the remaining solvents of the wet PVDF layer 6 be evaporated completely, and only a dried film of PVDF membrane 12 remains on the surface of the substrate 3. FIG. 6 also shows a cutting mechanism of the edges of the dried membrane 12 with a cutting tool 11 that contacts the edges of the substrate 3 to uncouple the dried PVDF membrane 12 from the surface of substrate 3 at the edge regions of them while spinning them around axis 4. The spinning of substrate 3 and dried PVDF membrane 12 can be continued until the coupled edges are completely separated.

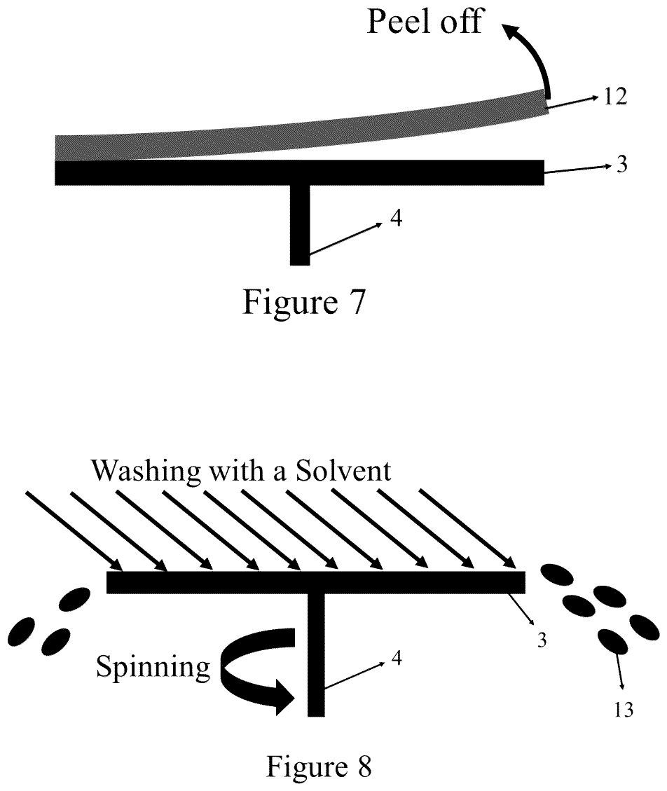

FIG. 7 shows a peeling-off process of the dried PVDF membrane 12 from the surface of the substrate 3 by a clip tool after stopping the substrate spinning. The peeled PVDF membrane 12 is now ready for applications within related industries.

After the peeling-off process, some dried PVDF particles might remain on the substrate's surface 3. However, the existence of these remaining contaminants can cause defects within the next cycle of manufacturing. Therefore, FIG. 8 is drawn to show a washing process of substrate 3 with a solvent such as ethanol or any other solvents that can be followed by deionized water while spinning the substrate 3 around the axis 4. The spinning of substrate 3 during the washing process spreads the washing material 13 out, which can be collected to be recycled and reused again in the next manufacturing process. The washing process can be continued until all contaminants are removed from the surface of the substrate 3.

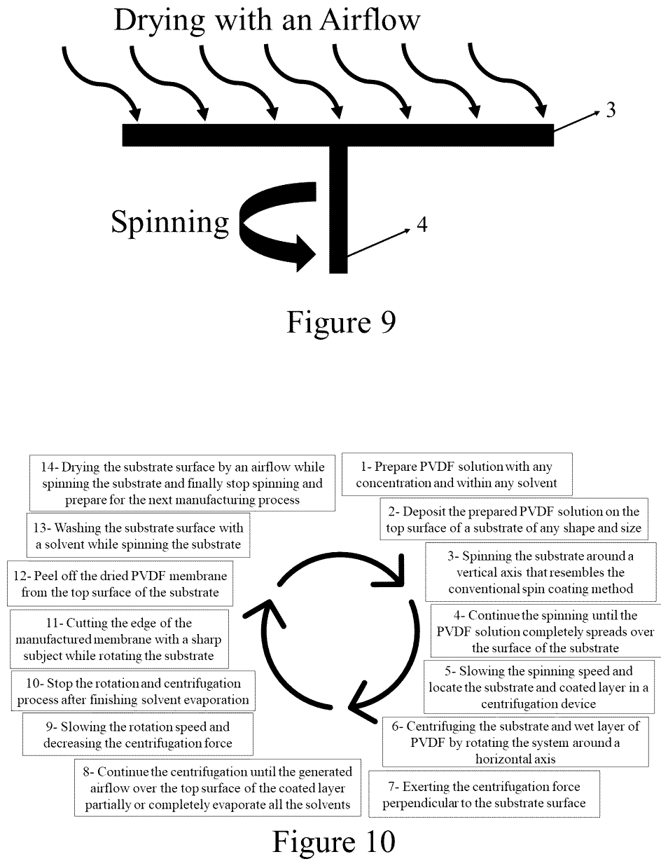

After the washing process, the surface of substrate 3 can be dried in a dying process, represented in FIG. 9. The spinning of the substrate 3 can be continuously continued after the washing process to start the drying case. The drying process can be continued until the whole surface of the substrate 3 is completely dry without remaining solvents or deionized water. Now, substrate 3 is clean, dry, and ready to be employed for the next manufacturing process.

FIG. 10 shows a stepwise process chart that explains the disclosed manufacturing processes in detail, numbered from 1 to 14.

The disclosed method is experimentally employed to manufacture PVDF membranes under various centrifugation forces. Seven samples of PVDF membrane are experimentally manufactured according to the presented table in the last section named “Experiments”. The manufactured 7 samples under different centrifugation forces are testified by accurate measurement devices inside the laboratory to verify the increment of the β phase of the PVDF membrane, which is affected by the centrifugation force as the main goal of the disclosed method. In the following, the results of measurements by XRD, FTIR, Raman Spectroscopy, and SEM observations are represented and discussed in detail.

FIG. 11 shows X-Ray Diffraction (XRD) graphs and peaks of the manufactured PVDF membranes. Generally, the XRD characterization determines different phases of PVDF membranes. The position and intensity of these peaks can identify the phases of PVDF. However, some of them are exclusive to identifying specific phases. The following description represents the peaks event of XRD graphs. Generally, α, γ, and β phases have an intensive peak of around 20°. However, only α and γ phases show another peak around 18° which makes them distinguishable from the β phase. The α phase can be identified by some strong peaks at 2θ=17.66°, 18.30°, 19.90°, and 26.56° corresponding to diffraction planes of (100), (020), (110), and (021), respectively. Four weak peaks at 33.2°, 35.9°, 38.8°, and 41.1° corresponding to the diffraction planes of (130), (200), (002), and (111), respectively, can also identify the α monoclinic phase. The γ phase can be identified by the peaks at 18.5° and 19.2°, corresponding to the diffraction planes of (020) and (002), respectively, and a more intensive peak at 2θ=20.04° corresponding to the crystalline plane (110). Furthermore, the γ phase has a weak peak at 26.8° and a peak at around 39.0°, corresponding to the diffraction planes (022) and (211), respectively. A strong peak at 2θ=20.26°, corresponding to the total diffraction at (110) and (200) planes, represents the β phase. The β phase can also be identified by a strong peak at around 20.6° and a weak peak at 36.3°.

In this patent application, an Empyrean Panalytical XRD device scanned the membranes with copper anode material in a continuous mode. The scanning range is set to start at 10° and ends at 40° with an interval step of 0.0130°. The XRD scanning results of membranes are combined and shown as a graph in FIG. 11. The XRD measurements of sample 1 (synthesized under 1 g of earth's natural gravity without any centrifugation process as well as the conventional spin coating methods) showed a weak peak at 18.9° and an intensive diffraction peak at 20.47°. The X-ray diffractions of sample2 (synthesized under centrifugation of 50 g) also showed a weak peak at 18.9° and an intensive diffraction peak at 20.47° as well as sample1. The XRD for both samples 1 and 2 revealed the creation of a phase and γ phases of PVDF. The XRD measurements for samples 3, 5, and 6, synthesized under centrifugation of 100, 200, and 300 g, respectively, show an intensive peak at 20.7°, representing the creation of higher percentages of β phase. Furthermore, the XRD measurements for samples 4 and 7, synthesized under centrifugation of 150 and 500 g, respectively, show an intensive peak at 20.4°, which also represents the creation of higher percentages of β phase β phase. Consequently, the FTIR spectroscopy method is further employed in the next section to explain the phases of PVDF membranes.

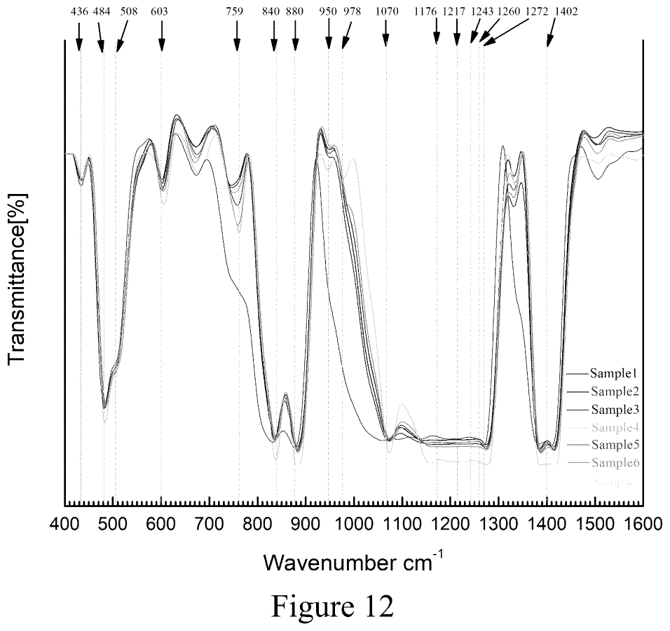

FIG. 12 shows Fourier Transform Infrared Spectroscopy (FTIR) graphs and peaks of the manufactured PVDF membranes. Generally, FTIR spectroscopy obtains valuable information on the microstructure and crystalline phases of PVDF. It identifies and quantitates different phases of PVDF, including α, β, and γ. The obtained transmittance spectrum of PVDF mainly shows several peaks at around 436, 483, 510, 512, 763, 836, 883, 1073, 1175, 1238, 1275, and 1405 cm⁻¹. The obtained peak at around 436 cm-1 shows the β, γ, and/or β+γ phases. However, identifying α, β, and γ phases using the FTIR in the 400-460 cm-1 range has shown uncertainties. The obtained peak at around 483 cm⁻¹ characterizes the γ phase, whereas the peaks at 510 and 512 cm⁻¹ characterize the β and γ phases, respectively. The peak at 763 cm⁻¹ is assigned to the α phase, whereas the peak at 840 cm⁻¹ characterizes the β, γ, and/or a combination of the β and γ phases. The intensity of the peaks at 763 and 840 cm⁻¹ can be utilized to evaluate the percentage of electroactive phases. The observed peaks at 883, 1073, and 1405 cm⁻¹ characterize the composition of α, β, and γ phases. The peak at approximately 1176 cm⁻¹ characterizes a composition of the β and γ phases. The peak at approximately 1234 cm⁻¹ characterizes β, γ, and/or β+γ phases. The peak at approximately 1276 cm⁻¹ exclusively characterizes the β phase.

The obtained peaks at 484, 603, 840, 880, 1070, 1176, 1217, 1243, 1260, 1272, and 1402 cm⁻¹ show an increase in the intensity of transmittance spectroscopy for the samples 2-7 synthesized under centrifugation forces. The peaks at 840 and 1243 cm⁻¹ reveal β, γ, and/or a combination of and γ phases. The peaks at 510 and 1270 exclusively show the β phase. The peaks at 483 and 512 exclusively represent the γ phase. The obtained FTIR peaks show an increase in the β, γ, and/or a combination of β and γ phases for the samples 2-7 synthesized under elevated centrifugation force, specifically for the sample7 with the highest centrifugation force using the disclosed method. Furthermore, the obtained peak at 759, which exclusively identifies the α phase, shows a decrease in the intensity of transmittance spectroscopy in the samples 2-7 manufactured by the disclosed method. Finally, the obtained FTIR peaks result in a reduction of the percentage of the Alpha (α) phase and an increase in the percentage of the electroactive Beta (β) phase for the membranes synthesized under elevated centrifugation force using the disclosed method.

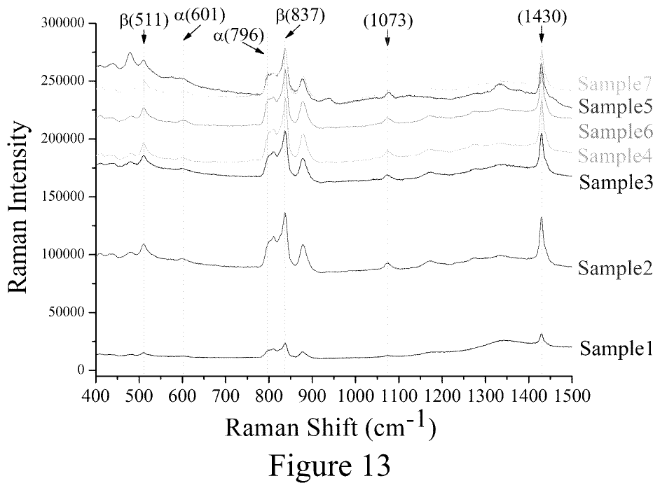

FIG. 13 shows Raman Spectroscopy graphs and peaks of the manufactured PVDF membranes. Considering the Raman spectra, in particular, for the case of the β phase of PVDF, intensive peaks must be found at around 261, 509, and 1275 cm⁻¹ and the most important one at 838 cm⁻¹. On the other hand, a phase of PVDF can be found at 290, 359, 415, 490, 540, 614, 977, 1298, and 1332 cm⁻¹, and the most important one at 800 cm⁻¹. All of them have a theoretical counterpart that can be identified unambiguously. On these grounds, the analysis of the sample containing both a and β phases is particularly meaningful: the comparison with the spectrum of pure α-PVDF reveals the presence of a small amount of β-PVDF, which is indeed responsible for the occurrence of the signal at 838 cm⁻¹, of the middle band of the triplet at 509 cm⁻¹, and of the shoulder at 1275 cm⁻¹, thus providing further confirmation of these assignments. It should also be noted that the sample composed mainly of the β phase presents intense signals at 800, 614, and 415 cm⁻¹ due to the impurity of the α phase, which is still present.

As it can be seen from FIG. 13, the intensity of Raman spectroscopy peaks at around 511 and 837 cm⁻¹ for the samples 2-7 that are synthesized under elevated centrifugation force using the disclosed method are significantly greater than the sample1 synthesized under 1 g earth's gravity force (like the conventional spin coating methods). It concludes that using disclosed method approves a significant increase in the electroactive phases of PVDF membranes while employing the disclosed method for manufacturing.

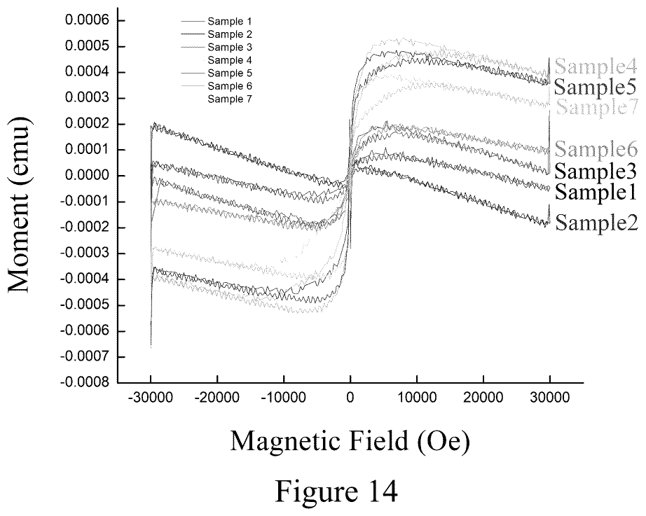

FIG. 14 shows moment vs. magnetic field (M-H) graphs obtained with a Vibrating Sample Magnetometer (VSM) device for the manufactured PVDF membranes. Thin Film Electronics successfully demonstrated roll-to-roll printed nonvolatile memories based on ferroelectric polymers in 2009. The ferroelectric property exhibits polarization-electric-field-hysteresis loop, which is related to “memory”. One application combines ferroelectric polymer Langmuir-Blodgett (LB) films with semiconductor technology to produce nonvolatile random-access memory and data-storage devices. Ferroelectric polymers are a group of crystalline polar polymers that are also ferroelectric, meaning they maintain a permanent electric polarization that can be reversed or switched in an external electric field. First reported in 1971, ferroelectric polymers are polymer chains that must exhibit ferroelectric behavior, hence piezoelectric and pyroelectric behavior. A ferroelectric polymer must contain permanent electrical polarization that can be reversed repeatedly by an opposing electric field. [4] In the polymer, dipoles can be randomly oriented, but applying an electric field will align the dipoles, leading to ferroelectric behavior. This patent proposes that the centrifugation force, while the coated membrane is still wet, can align the dipoles of the PVDF membrane so that the ferroelectricity and magnetic performance of the PVDF membrane synthesized by the disclosed method can be enhanced. To approve the mentioned proposition, all 7 samples of manufactured membranes under various centrifugation forces are testified by a Vibrating Sample Magnetometer (VSM) device, and the result of tests is reported as a graph in FIG. 14. As can be seen in FIG. 14, the membranes synthesized under higher centrifugation forces show a greater moment (emu) while increasing or decreasing the magnetic field (Tesla). More particularly, samples 4 and 5 synthesized under 150 and 200 g, respectively, shows the highest moment (emu) among the other samples. The disclosed method approves the enhanced ferroelectric and magnetic properties for the synthesized membranes under elevated centrifugation force.

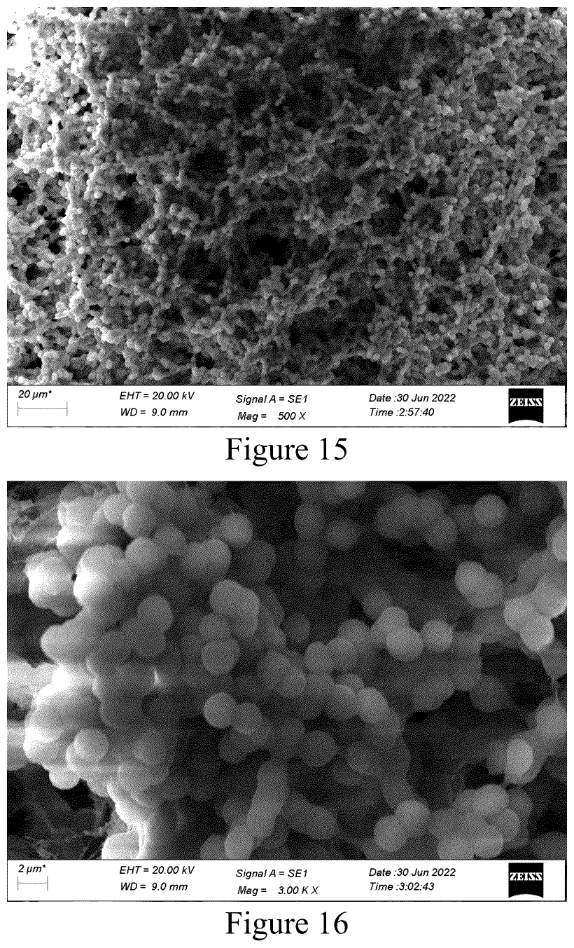

FIGS. 15 to 30 show SEM images for the manufactured PVDF membranes. An SEM device images the surface and cross-section of PVDF membranes (samples 1, 3, 5, and 7) synthesized under various centrifugation forces using the disclosed method. Surface and cross-section SEM images of sample1 synthesized under earth's natural gravity 1 g (look like the conventional spin coating methods) at different magnifications are shown in FIGS. 15, 16, 17, and 18. The surface and cross-section SEM images of sample1 show the existence of individual spherical particles accumulated adjacent to each other. The SEM measures the diameter of the spherical particles in a range between 2 and 3 μm. These spherical elements are polymer-rich regions that accumulate to each other after solvents' evaporation. Surface and cross-section SEM images of samples 3, 5, and 7 synthesized under 100, 200, and 500 g centrifugation force are shown in FIGS. 19-30. The SEM images represent the formation of denser membranes with less porosities under elevated centrifugation force using the disclosed method. The elevation of centrifugation force pushes the solvents to move toward the free surface of the coating quickly and evaporate before complete solidification. Therefore, the solvent's free spaces are filled by the polymeric elements of the PVDF solution. The SEM images also show that the polymeric chain structure of membranes using the disclosed method is significantly different and compressed from the sample1 synthesized without any centrifugation forces. More particularly, the spherical particles in sample1, are combined with each other and generate a chain of polymers with less porosities in the samples synthesized under elevated centrifugation force. It seems the centrifugation force changes the membranes' polymeric structure, which is extensively discussed in XRD, FTIR, and Raman Spectroscopy investigation sections.

### Technical Conclusion for the Disclosed Method

The elevation of centrifugation force within the disclosed method causes the solvents of PVDF solution to move toward the surface of the membrane faster than in the ordinary case. Therefore, the solvents' evaporation time using the disclosed method is significantly decreased. XRD, FTIR, and Raman tests revealed the alteration of the PVDF crystalline structure. Phase transitions from a toward the electroactive phases (B, Y, or a combination of β and γ) happened while elevating the centrifugation force using the disclosed method. Finally, the experiments showed that the polymerization and the phase transitions of PVDF membranes are sensitive to the centrifugation force using the disclosed method, which ensures the increment in the percentage of electroactive phases of the PVDF membrane. The disclosed method also enhances the moment (emu) values of membranes synthesized under centrifugation forces while increasing or decreasing the magnetic field (Tesla). Furthermore, the time of manufacturing PVDF membranes is significantly reduced when the solvents of PVDF solution are evaporated faster due to the generated airflow on the surface of PVDF's wet film during the substrate rotation while increasing the centrifugation force. The manufacturing time decrement is one of the most desired demands within the related industries. Moreover, the low cost and easy operation can attract the owner of the industries to employ the disclosed method in their production lines.

What is claimed is:

1. A method for manufacturing Polyvinylidene Fluoride (PVDF) membranes comprising:
Prepare a PVDF solution with any concentration within any solvent as the coating material, in which may also include other materials and copolymers.
Deposit enough amount of the prepared PVDF solution on a top surface of a clean and dry substrate of any shape and size aligned at the center of a horizontal spinning system;
Adjusting values for spinning speed, spinning acceleration, and spinning time, which can alternate between two or more different settings;
Adjusting values for centrifugation force, centrifugation acceleration, and centrifugation time which can alternate between two or more different settings;
Spinning the substrate and the deposited prepared PVDF solution according to the adjusted values around a vertical axis like a conventional spin coating method;
Continue the spinning until the prepared PVDF solution completely spreads over the top surface of the substrate to manufacture a wet layer;
Centrifuging the substrate that holds the wet layer according to the adjusted values around a horizontal axis in which the centrifugation force is normal and perpendicular to the surface of the substrate.
Continue the centrifugation of the substrate according to the adjusted values until a generated airflow over the top surface of the wet layer completely or partially evaporate the solvents of the wet layer to manufacture a dried membrane;
Slowing the centrifugation force in which the substrate is again horizontally as well as the beginning of the process.
Contacting a sharp subject to cut and uncouple the edge of the manufactured dried membrane from the top surface of the substrate at edges while spinning the substrate.
Slowing the spinning of the substrate;
Peel off the dried membrane from the top surface of the substrate with a subject;
Washing the surface of the substrate with a solvent and then with a deionized water while spinning the substrate;
Drying the surface of the substrate with an air dryer and finally slowing the spinning; and
Repeating the steps mentioned earlier for manufacturing PVDF membranes for consequent products.

2. A method for manufacturing Polyvinylidene Fluoride (PVDF) membranes, according to claim 1, is employed to increase the electroactive phase (β-phase) of PVDF membranes.

3. A method for manufacturing Polyvinylidene Fluoride (PVDF) membranes, according to claim 1, is employed to enhance the ferroelectric properties of PVDF membranes.

4. A method for manufacturing Polyvinylidene Fluoride (PVDF) membranes, according to claim 1, is employed to enhance moment values of electromagnetic properties of PVDF membrane under a magnetic field.

5. A method for manufacturing Polyvinylidene Fluoride (PVDF) membranes, according to claim 1, in which a spinning axis is vertical.

6. A method for manufacturing Polyvinylidene Fluoride (PVDF) membranes, according to claim 1, in which centrifugation force is perpendicular to the substrate surface and normal to PVDF wet coated layer.

7. A method for manufacturing Polyvinylidene Fluoride (PVDF) membranes, according to claim 1, in which rotation axis for generating centrifugation force is horizontal.

8. A method for manufacturing Polyvinylidene Fluoride (PVDF) membranes, according to claim 1, in which rotation axis for generating centrifugation force is perpendicular to the spinning axis.

9. A method for manufacturing Polyvinylidene Fluoride (PVDF) membranes, according to claim 1, in which centrifugation force rotates Fluoride atoms (F), as the heavier atoms of PVDF polymer, toward the bottom of the wet layer and rotates Hydrogen atoms (H), as the lighter atoms of PVDF polymer, toward the top of wet layer.

10. A method for manufacturing Polyvinylidene Fluoride (PVDF) membranes, according to claim 1, in which decreases the time of solvents release.

11. A method for manufacturing Polyvinylidene Fluoride (PVDF) membranes, according to claim 1, in which an airflow generated during centrifugation increases solvent evaporation rate.

12. A method for manufacturing Polyvinylidene Fluoride (PVDF) membranes, according to claim 1, in which the time of manufacturing PVDF membrane decreases.

13. A method for manufacturing Polyvinylidene Fluoride (PVDF) membranes, in which the crystalline structure of a manufactured PVDF membrane changes from alpha (α) phase to Beta (β) phase.

14. A method for manufacturing Polyvinylidene Fluoride (PVDF) membranes, in which centrifugation increases the polarity of PVDF and enhances the electroactivity of manufactured PVDF membrane.
